(19) United States
(12) Patent Application Publication
(10) Pub. No.: US 2007/0058119 A1
(43) Pub. Date: Mar. 15, 2007

(54) Liquid crystal display and light-emitting element

(75) Inventor: Tomoki Tasaka, Kanagawa (JP)

Correspondence Address: SUGHRUE-265550, 2100 PENNSYLVANIA AVE. NW, WASHINGTON, DC, 20037-3213, US

(73) Assignee: FUJI PHOTO FILM CO., LTD.

(21) Appl. No.: 11/518,319

(22) Filed: Sep. 11, 2006

(30) Foreign Application Priority Data
Sep. 12, 2005 (JP) P2005-263671

(51) Int. Cl. G02F 1/1335

(52) U.S. Cl. 349/117

(57) ABSTRACT

A liquid crystal display includes: a light emitting element utilized as a light source of a backlight, and emitting a linearly polarized light; a liquid crystal cell stacked on the light emitting element; a polarizer film stacked on the liquid crystal cell; and at least one retardation film stacked in at least one of a gap between the light emitting element and the liquid crystal cell and a gap between the liquid crystal cell and the polarizer film.

### BACKGROUND OF THE INVENTION

1. Field of the Invention

The present invention relates to a liquid crystal display utilizing a linearly polarized light emitting element emitting linearly polarized light as a light source of a backlight.

2. Background Art

In general, a light source emitting non-polarized light is used as a backlight for a transmissive liquid crystal display. Further, two polarizers are formed on a backlight of a transmissive liquid crystal display. As a result, a major part of non-polarized light emitted by the light source of the backlight is absorbed by the two polarizers, which results in low utilization of light.

On the contrary, when a light source emitting linearly polarized light is used as a light source of a backlight as disclosed in JP-A-306954 (the term “JP-A” as used herein means an “unexamined published Japanese patent application), it is required to stack only one polarizer on the light source, which allows improved utilization of light. When such a light source is used, however, it is important to prevent leakage of light when the display surface of the liquid crystal display is observed in an oblique direction while black is displayed.

### SUMMARY OF THE INVENTION

The present invention was made taking the above-described situation in consideration, and it is an object of the invention to improve the viewing angle characteristics of a liquid crystal display utilizing a light source emitting linearly polarized light as a light source of a backlight.

(1) According to a first aspect of the present invention, a liquid crystal display comprising: a light emitting element utilized as a light source of a backlight, and emitting a linearly polarized light; a liquid crystal cell stacked on the light emitting element; a polarizer film stacked on the liquid crystal cell; and at least one retardation film stacked in at least one of a gap between the light emitting element and the liquid crystal cell and a gap between the liquid crystal cell and the polarizer film.

(2) The liquid crystal display as described in the item (1), wherein the light emitting element emits a linearly polarized light in a direction perpendicular to an axis of emission thereof, and the polarizer film transmits a polarized light in a direction perpendicular to an optical axis thereof.

(3) The liquid crystal display as described in the item (1), wherein the light emitting element emits a linearly polarized light in a direction parallel to an axis of emission thereof, and the polarizer film transmits a polarized light in a direction parallel to an optical axis thereof.

(4) According to a second aspect of the present invention, a liquid crystal display comprising: a light emitting element utilized as a light source of a backlight, and emitting a linearly polarized light in a direction perpendicular to an axis of emission thereof; a liquid crystal cell stacked on the linearly polarized light emitting element; and a polarizer film stacked on the liquid crystal cell, and transmitting a polarized light in a direction parallel to an optical axis thereof.

(5) The liquid crystal display as described in any of the items (1) to (4), wherein the liquid crystal cell is a liquid crystal cell of an in-plane-switching type.

(6) According to a third aspect of the present invention, a light-emitting element comprising: a light emitting element emitting a linearly polarized light in a direction perpendicular to an axis of emission thereof; and a retardation film applied to a light-emitting surface of the light emitting element.

(7) According to a fourth aspect of the present invention, a light-emitting element comprising: a light emitting element emitting a linearly polarized light in a direction parallel to an axis of emission thereof; and a retardation film applied to a light-emitting surface of the light emitting element.

The invention makes it possible to improve the viewing angle characteristics of a liquid crystal display utilizing a light source emitting linearly polarized light as a light source of a backlight.

### BRIEF DESCRIPTION OF THE DRAWINGS

The invention disclosed herein will be understood better with reference to the following drawings of which:

FIG. 1 is a sectional view showing a schematic configuration of a liquid crystal display representing a mode for carrying out the invention;

FIGS. 2A and 2B are illustrations for explaining characteristics of O-type and E-type linearly polarized light emitting elements;

FIGS. 3A and 3B are illustrations for explaining characteristics of O-type and E-type polarizer films;

FIGS. 4A to 4C are illustrations showing exemplary configurations in which an optical retardation film is used in the liquid crystal display shown in FIG. 1;

FIG. 5 is a table showing conditions for liquid crystal displays used for simulation;

FIG. 6 is a table showing conditions for liquid crystal displays used for simulation;

FIG. 7 is a table showing conditions for liquid crystal displays used for simulation; and

FIG. 8 is a table showing simulation results.

### DETAILED DESCRIPTION OF THE INVENTION

A mode for carrying out the invention will now be described with reference to the drawings.

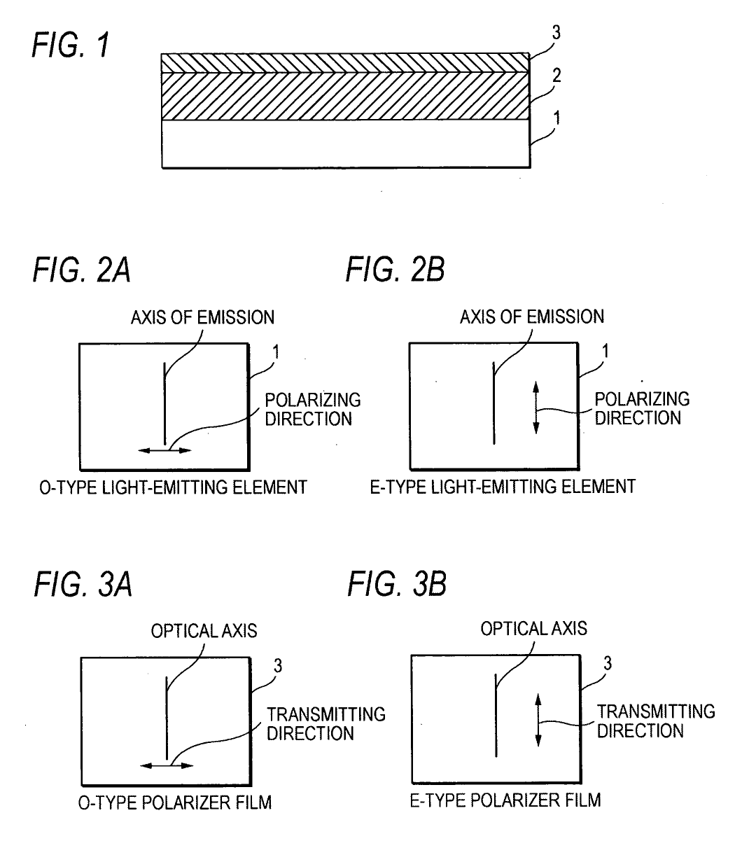

FIG. 1 is a sectional view showing a schematic configuration of a liquid crystal display representing a mode for carrying out the invention.

The liquid crystal display shown in FIG. 1 includes a linearly polarized light emitting element 1 emitting linearly polarized light, a liquid crystal cell 2 formed on the linearly polarized light emitting element 1, and a polarizer film 3 formed on the liquid crystal cell 2. An image is displayed at the liquid crystal cell 2 with the linearly polarized light emitting element 1 serving as a light source of a backlight. The liquid crystal cell 2 is constituted by a liquid crystal layer, a pair of glass substrates sandwiching the liquid crystal layer, an electrode for applying a voltage to the liquid crystal layer, and so on. The cell may be of types such as TN (Twisted Nematic), VA (Vertical Alignment), OCB (Optically Compensated Birefringence), and IPS (In-Plane-Switching) types.

Linearly polarized light emitting elements include O-type and E-type elements, and polarizer films also include O-type and E-type films.

FIGS. 2A and 2B are illustrations for explaining characteristics of O-type and E-type linearly polarized light emitting elements, in which 2A represents a plan view of an O-type linearly polarized light emitting element, and 2B represents a plan view of an E-type linearly polarized light emitting element.

As shown in FIG. 2A, the O-type linearly polarized light emitting element emits linearly polarized light in a direction perpendicular to an axis of emission thereof. Methods for causing the emission of linearly polarized light include a method in which molecules are oriented in the same direction. According to this method, the axis of symmetry of molecules is an axis of emission as described above in most cases. In the present mode for carrying out the invention, it is assumed that an axis of emission of a linearly polarized light emitting element and an axis of emission of molecules included in the same are the same thing. For example, the O-type linearly polarized light emitting element may be an organic EL element utilizing a discotic liquid crystal in which liquid crystal molecules are aligned in one direction using a rubbing process.

As shown in FIG. 2B, the E-type linearly polarized light emitting element emits linearly polarized light in a direction parallel to an axis of emission thereof. For example, the E-type linearly polarized light emitting element may be an organic EL element utilizing a calamitic liquid crystal in which liquid crystal molecules are aligned in one direction using a rubbing process.

FIGS. 3A and 3B are illustrations for explaining characteristics of O-type and E-type polarizer films, in which 3A represents a plan view of the O-type polarizer film, and 3B represents a plan view of the E-type polarizer film.

As shown in FIG. 3A, the O-type polarizer film transmits linearly polarized light in a direction perpendicular to an optical axis thereof. For example, the O-type polarizer film may be a film obtained by stretching PVA colored using iodine.

As shown in FIG. 3B, the E-type polarizer film transmits linearly polarized light in a direction parallel to an optical axis thereof. For example, the E-type polarizer film may be a film utilizing dichroic pigment manufactured by Optiva Inc.

In the liquid crystal display shown in FIG. 1, two types of elements, i.e., O-type and E-type elements may be used as the linearly polarized light emitting 1, and two types of films, i.e., O-type and E-type films may be used as the polarizer film 3. Therefore, there are four combinations of those components as follows.

(1) a linearly polarized light emitting element 1 of O-type and a polarizer film 3 of O-type

(2) a linearly polarized light emitting element 1 of O-type and a polarizer film 3 of E-type

(3) a linearly polarized light emitting element 1 of E-type and a polarizer film 3 of O-type

(4) a linearly polarized light emitting element 1 of E-type and a polarizer film 3 of E-type

The linearly polarized light emitting element 1 and the polarizer film 3 are disposed such that no light exit the polarizer film 3 when black is displayed by the liquid crystal cell 2, and a simulation is carried out to calculate the amount of leakage of light when the liquid crystal cell 2 is observed in an oblique direction. For example, in the case (1), the linearly polarized light emitting element 1 and the polarizer film 3 are disposed such that the axis of emission and the optical axis are orthogonal to each other. In the case (2), the linearly polarized light emitting element 1 and the polarizer film 3 are disposed such that the axis of emission and the optical axis are parallel to each other. In the case (3), the linearly polarized light emitting element 1 and the polarizer film 3 are disposed such that the axis of emission and the optical axis are parallel to each other. In the case (4), the linearly polarized light emitting element 1 and the polarizer film 3 are disposed such that the axis of emission and the optical axis are orthogonal to each other.

Results of the simulation indicated that there is the amount of leakage of light is small in the cases of the combinations (2) and (3) even when the liquid crystal cell 2 is observed in an oblique direction.

It was also revealed that leakage of light in an oblique view of the liquid crystal cell 2, which is noticeable in the cases of the combinations (1) and (4), can be reduced by using at least one optical retardation film.

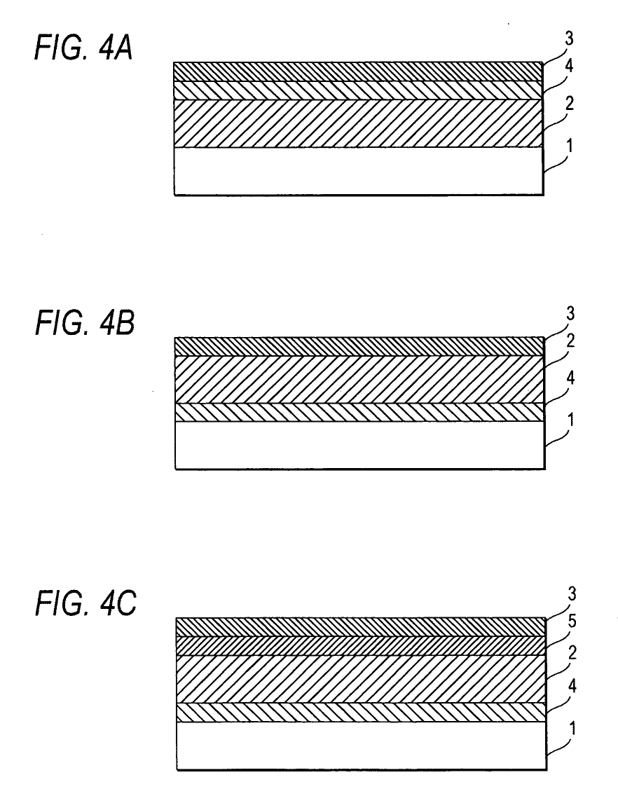

FIGS. 4A to 4C are illustrations showing exemplary configurations in which an optical retardation film is used in the liquid crystal display 1 shown in FIG. 1. Features in FIGS. 4A to 4C identical to those in FIG. 1 are indicated by like reference numerals.

The liquid crystal display shown in FIG. 4A has a configuration in which an optical retardation film 4 is provided between the liquid crystal cell 2 and the polarizer film 3. The optical retardation film 4 interposed may be provided by stacking a plurality of optical retardation films.

The liquid crystal display shown in FIG. 4B has a configuration in which an optical retardation film 4 is provided between the linearly polarized light emitting element 1 and the liquid crystal cell 2. The optical retardation film 4 interposed may be provided by stacking a plurality of optical retardation films. Although each of the linearly polarized light emitting element 1, the liquid crystal cell 2, the polarizer film 3, and the optical retardation film 4 is a member that is independently sold, the linearly polarized light emitting element 1 and the optical retardation film 4 may alternatively be sold as an integral member provided by applying the optical retardation film 4 to a light-emitting surface of the linearly polarized light emitting element 1.

The liquid crystal display shown in FIG. 4C has a configuration in which an optical retardation film 4 is provided between the linearly polarized light emitting element 1 and the liquid crystal cell 2 and in which an optical retardation film 5 is provided between the liquid crystal cell 2 and the polarizer film 3. Each of the optical retardation films 4 and 5 may be provided by stacking a plurality of optical retardation films. Although each of the linearly polarized light emitting element 1, the liquid crystal cell 2, the polarizer film 3, the optical retardation film 4, and the optical retardation film 5 is an independent member, the linearly polarized light emitting element 1 and the optical retardation film 4 may alternatively be sold as an integral member provided by applying the optical retardation film 4 to a light-emitting surface of the linearly polarized light emitting element 1.

Conditions for the simulation will now be described.

The wavelength of light emitted by the linearly polarized light emitting element was 550 nm, and the degree of polarization was 30000, the degree of polarization being represented by the ratio between a maximum quantity of light and a minimum quantity of light obtained when the linearly polarized light emitting element was observed with the polarizer film rotated.

The liquid crystal cell 2 was of the IPS type, and it had a retardation value (Re) of 300 nm and a pre-tilt angle of 0 deg.

All of the optical retardation films were biaxial. The material of the biaxial optical retardation films may be a compressed or stretched polycarbonate film. As values to characterize the optical retardation films, retardation values (Re) expressed as (nx₁−ny₁)×d₁, thickness direction retardation values (Rth) expressed as ((nx₁+ny₁)/2−nz₁)×d₁, and Nz-values expressed as ((nx₁−nz₁)/(nx₁−ny₁) were used where the direction in which the optical retardation films had a maximum in-plane refractive index was designated as an X-axis; a direction perpendicular to the X-axis was designated as a Y-axis; the direction of the thickness of the films was designated as a Z-axis; refractive indices in the axial directions were represented by nx₁, ny₁, and nz₁, respectively; and the thickness was represented by d₁.

A reference axis was set on the display surface of the liquid crystal display, and the angle defined by the reference axis and an in-plane axis of each of the components was represented by φ (the in-plane axis being an axis of emission in the case of a linearly polarized light emitting element, the direction of alignment of liquid crystal molecules in the case of a liquid crystal cell, a phase-lag axis in the case of a positive A plate, a phase-lead axis in the case of a negative A plate, the X-axis described above in the case of a biaxial optical retardation film, and an optical axis in the case of a polarization film). There is no need for specifying a direction for a C plate because it has no axis in a particular direction in the plane of the film.

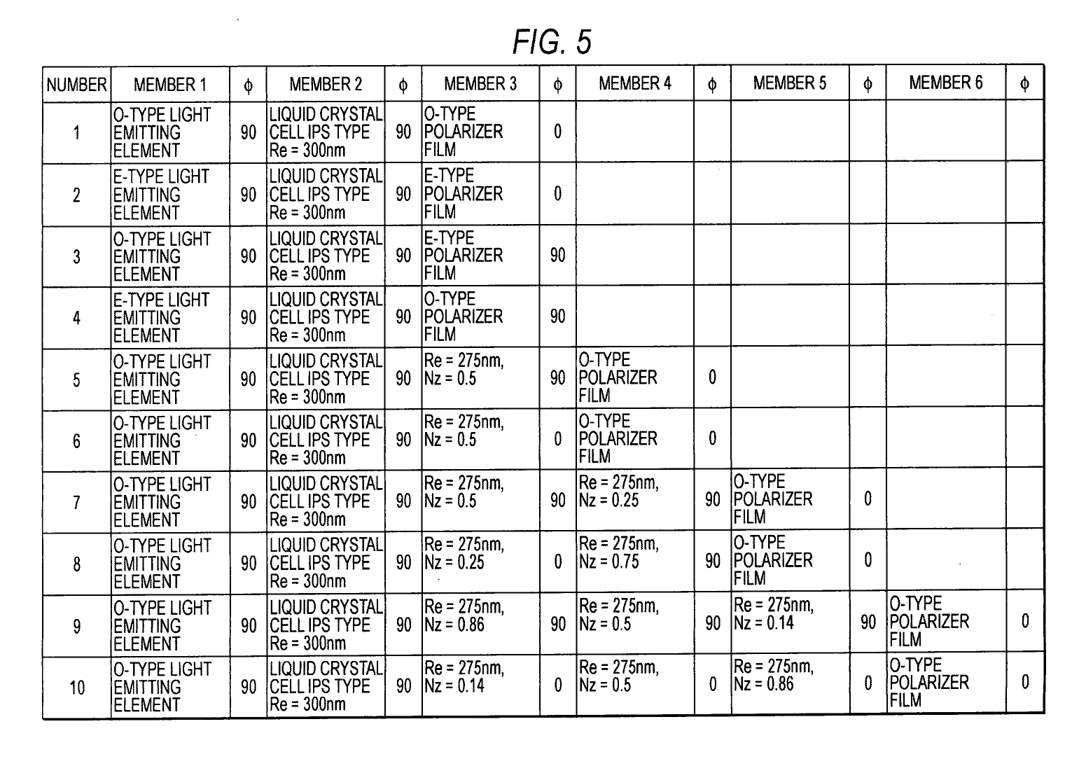

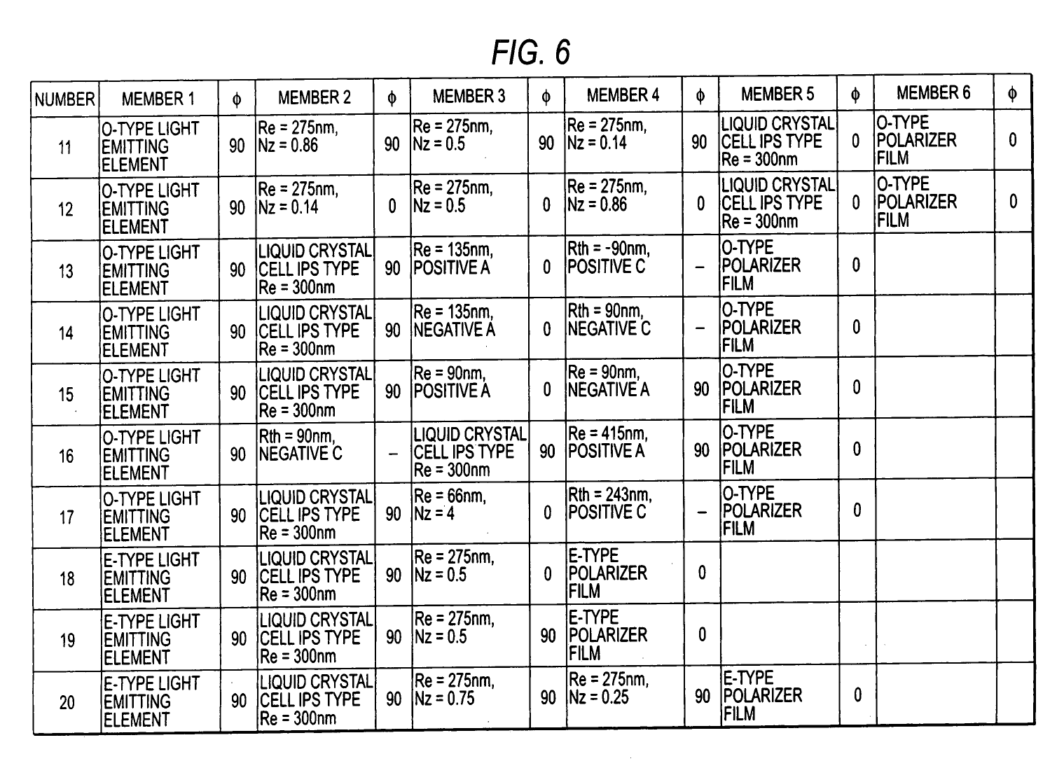

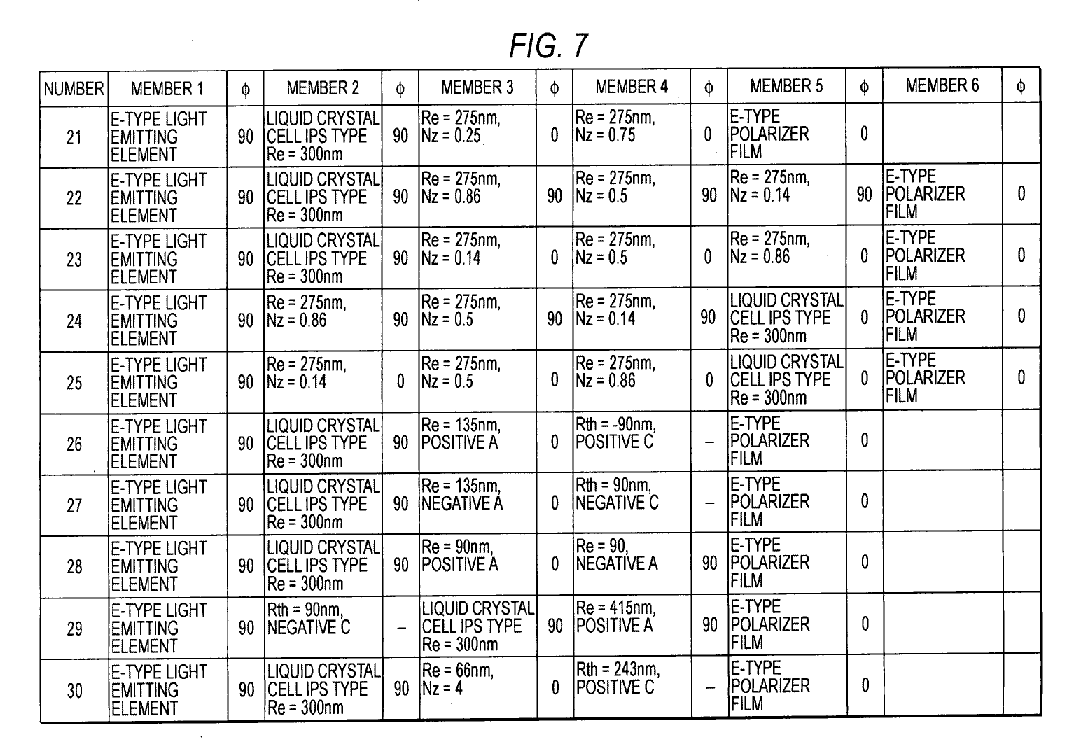

Simulations 1 and 2 for comparison and Simulations 3 to 30 were carried out with conditions for liquid crystal displays set as shown in FIGS. 5 to 7.

The items designated as “number” in FIGS. 5 to 7 represent the simulation numbers.

In each of the columns indicated by the numbers, components (members) of the simulated liquid crystal display are listed in the left-to-right order that is the order in which the components were formed. For example, it will be understood that an O-type linearly polarized light emitting element, a liquid crystal cell, and an O-type polarizer film are formed in the order listed in the liquid crystal display in Simulation 1.

“φ” shown on the right of each member represents the angle φ of the member. In the case of Simulation 1, the symbol indicates that an axis of emission of the O-type linearly polarized light emitting element is orthogonal to the reference axis; the direction of alignment of the liquid crystal cell is orthogonal to the reference axis; and an optical axis of the O-type polarizer film is parallel to the reference axis.

Referring to the items designated as “members” in FIGS. 5 to 7, members other than the linearly polarized light emitting elements, liquid crystal cells, and polarizer films are all optical retardation films.

“positive A” indicates that an optical retardation film is a positive A plate. The material of a positive A plate may be a stretched polycarbonate film.

“negative A” indicates that an optical retardation film is a negative A plate. The material of a negative A plate may be a film on which a discotic liquid crystal is applied with the director aligned in the horizontal direction.

“positive C” indicates that an optical retardation film is a positive C plate. The material of a positive C plate may be a film on which a calamitic liquid crystal is applied in vertical alignment.

“negative C” indicates that an optical retardation film is a negative C plate. The material of a negative C plate may be a TAC film or a film on which a discotic liquid crystal is applied with the director aligned in the vertical direction.

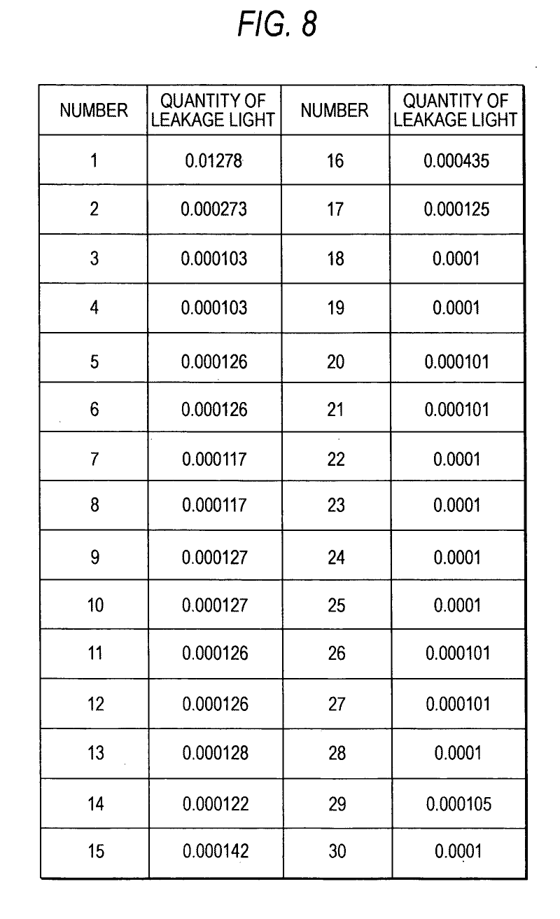

Optical simulations were carried out using an expanded Jones matrix to identify the quantities of leakage beams generated when the liquid crystal cells displaying black were observed at an azimuth angle of 45 deg and a polar angle of 60 deg on an assumption that the quantity of light emitted by the linearly polarized light emitting elements was 1. FIG. 8 shows the results.

The results shown in FIG. 8 indicated that the quantities of leakage light in Simulations 3 to 30 were smaller than those in Simulations 1 and 2.

It was revealed from the results that the configurations shown in FIGS. 4A and 4B allow leakage of light to be suppressed when Re of an optical retardation film is one-half of the wavelength of light incident thereon and Nz of the film is 0.5. It was also revealed that leakage of light can be suppressed when a plurality of optical retardation films are formed in the configurations shown in FIGS. 4A and 4B if Re of each of the retardation films is one-half of the wavelength of light incident thereon and if the sum of Nz's of the optical retardation films is 0.5×i (i represents the number of the optical retardation films).

Further, it was revealed that leakage of light can be suppressed by using optical retardation films having characteristics as shown in Simulations 13, 14, 15, 17, 26, 27, 28, and 30 in FIGS. 5 to 7 when two optical retardation films are used in the configurations shown in FIGS. 4A and 4B.

It was further revealed that leakage of light can be suppressed by using optical retardation films having characteristics as shown in Simulations 16 and 29 in FIGS. 5 to 7 when the configuration shown in FIG. 4C is employed.

(Embodiment)

An embodiment of the invention will now be described.

In the present embodiment, liquid crystal displays were fabricated under the same conditions as Simulations 1 to 30 described above, and direct observation was conducted on them under the same conditions as Simulations 1 to 30.

As a result, the quantities of leakage light observed at the liquid crystal displays other than the liquid crystal displays having the same configurations as Simulations 1 and 2 were smaller.

The present application claims foreign priority based on Japanese Patent Application (JP 2005-263671) filed Sep. 12 of 2006, the contents of which is incorporated herein by reference.

What is claimed is:

1. A liquid crystal display comprising:
a light emitting element utilized as a light source of a backlight, and emitting a linearly polarized light;
a liquid crystal cell stacked on the light emitting element;
a polarizer film stacked on the liquid crystal cell; and
at least one retardation film stacked in at least one of a gap between the light emitting element and the liquid crystal cell and a gap between the liquid crystal cell and the polarizer film.

2. The liquid crystal display according to claim 1, wherein
the light emitting element emits a linearly polarized light in a direction perpendicular to an axis of emission thereof, and
the polarizer film transmits a polarized light in a direction perpendicular to an optical axis thereof.

3. The liquid crystal display according to claim 1, wherein
the light emitting element emits a linearly polarized light in a direction parallel to an axis of emission thereof, and
the polarizer film transmits a polarized light in a direction parallel to an optical axis thereof.

4. A liquid crystal display comprising:
a light emitting element utilized as a light source of a backlight, and emitting a linearly polarized light in a direction perpendicular to an axis of emission thereof;
a liquid crystal cell stacked on the linearly polarized light emitting element; and
a polarizer film stacked on the liquid crystal cell, and transmitting a polarized light in a direction parallel to an optical axis thereof.

5. The liquid crystal display according to claim 1, wherein the liquid crystal cell is a liquid crystal cell of an in-plane-switching type.

6. A light-emitting element comprising:
a light emitting element emitting a linearly polarized light in a direction perpendicular to an axis of emission thereof; and
a retardation film applied to a light-emitting surface of the light emitting element.

7. A light-emitting element comprising:
a light emitting element emitting a linearly polarized light in a direction parallel to an axis of emission thereof; and
a retardation film applied to a light-emitting surface of the light emitting element.
